(19) United States
(12) Patent Application Publication
(10) Pub. No.: US 2002/0047479 A1
(43) Pub. Date: Apr. 25, 2002

(54) Motor having an insulating apparatus for preventing withstand voltage of a stator

(76) Inventor: Jong-Hyun Choi, Kwangju-city (KR)

Correspondence Address: Elaine H. Lo, SKJERVEN MORRILL MacPHERSON LLP, Suite 700, 25 Metro Drive, San Jose, CA, 95110-1349, US

(21) Appl. No.: 09/804,924

(22) Filed: Mar. 12, 2001

(30) Foreign Application Priority Data
May 2, 2000 (KR) 2000-23549

(51) Int. Cl. H02K 3/46

(52) U.S. Cl. 310/260

(57) ABSTRACT

A motor includes a stator, a rotor disposed in the stator, a coil and an insulating apparatus. The coil has a main-resistance coil that is wound around an outer portion of an iron core of the stator and a sub-resistance coil that is wound around an inner portion of the iron core. The insulating apparatus prevents withstand voltage by insulating the rotor from the coil, which can expand and contact the rotor as a result of an increase in temperature during operation of the motor. The insulating apparatus includes an insulator disposed between the rotor and the coil and a yam for securing the insulator to the coil.

### BACKGROUND OF THE INVENTION

1. Field of the Invention

This invention relates to a motor, and more particularly, to a motor having an insulating apparatus for preventing withstand voltage of a stator by insulating a rotor from a coil, which is wound around the stator, when the coil becomes loose due to an increase in temperature of the operating motor.

2. Description of the Related Art

Generally, a motor using magnetic induction of a coil includes a stator 1, and a rotor 3 disposed in the center of the stator 1, as shown in FIGS. 1 and 2. A coil 2 is wound around an iron core (not shown) of the stator 1. The coil 2 is divided into a main-resistance coil 2a and a sub-resistance coil 2b.

As constructed above, the coil 2 is magnetically-induced by rotation of the rotor 3. The motor is driven by the magnetic induction of the coil 2.

However, problems arise when the above-constructed motor operates for a long period of time. The temperature of operating motor increases. As a result, the sub-resistance coil can become lose and may even separate from the iron core of the stator 1 due to the temperature increase.

In addition, when the sub-resistance coil 2b is loose, the sub-resistance coil 2b, as shown in FIG. 2, can touch an outer part A of the rotor 3. Such a contact causes withstand voltage.

Taking into consideration that the motor is usually employed in a device, such as a compressor, the device can be permanently damaged due to withstand voltage occurrence. If this happens, the compressor or other device is no longer of use, and the productivity and quality of the product in general are deteriorated.

### SUMMARY OF THE INVENTION

It is an object of the present invention to provide a motor having an improved insulating apparatus to prevent withstand voltage of a stator in a motor by insulating a rotor from a sub-resistance coil.

In accordance with one embodiment of the invention, a motor includes a stator, a rotor disposed in the stator, a coil having a main-resistance coil wound around an outer portion of an iron core of the stator and a sub-resistance coil wound around an inner portion of the iron core of the stator. The motor further includes an insulating apparatus for preventing withstand voltage by insulating the rotor from the sub-resistance coil, when the sub-resistance coil becomes loose due to an increase in the temperature of the motor and coil.

The insulating apparatus includes an insulator disposed between the sub-resistance coil and the rotor. The insulator is made of a material that is refrigerant-proof and oil-proof.

The insulating apparatus further includes a yarn for securing the insulator to the coil of the stator. The yarn is preferably made of a polyester material.

### BRIEF DESCRIPTION OF THE DRAWINGS

The present invention will be clarified by the description of the preferred embodiment in further detail with reference to the attached drawings.

FIG. 1 is a perspective view showing a stator employed in a conventional motor;

FIG. 2 is a plan view showing the motor having the stator shown in FIG. 1;

FIG. 3 is a schematic view showing an insulating apparatus for preventing withstand voltage of a stator in a motor according to the present invention; and

FIG. 4 is a perspective view showing the insulator of FIG. 3.

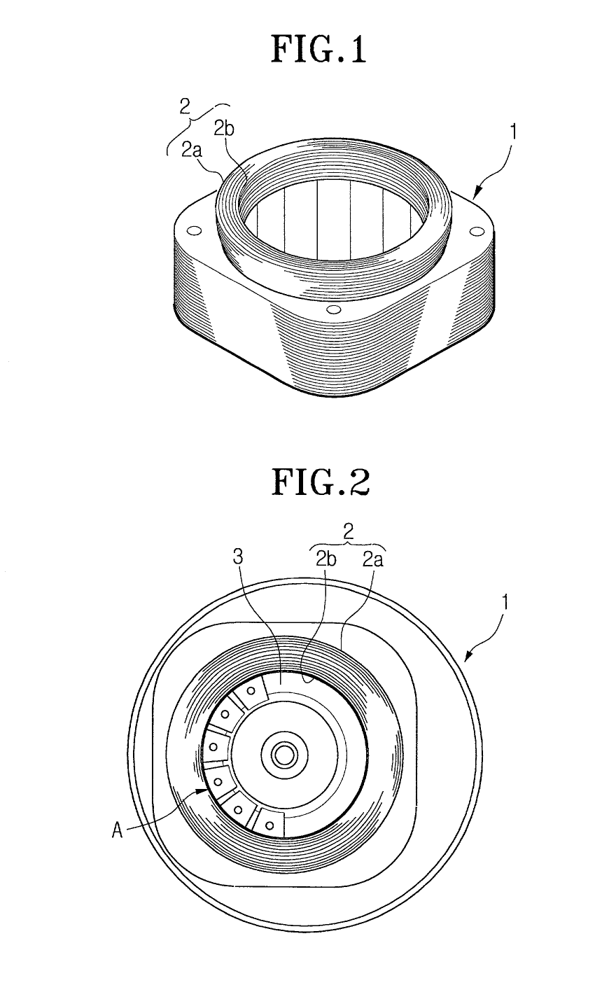

### DETAILED DESCRIPTION OF THE PREFERRED EMBODIMENT

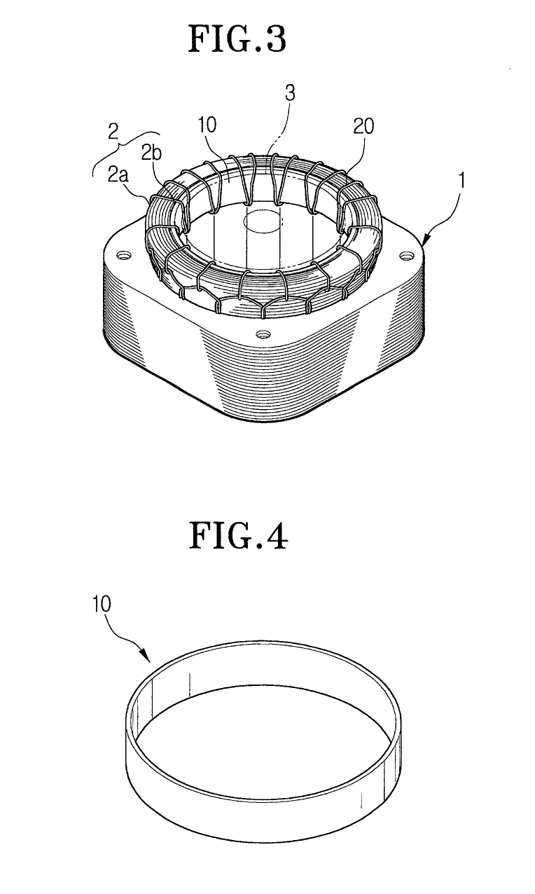

Referring to FIG. 3, an insulating apparatus for preventing withstand voltage of a stator in a motor according to the preferred embodiment of the present invention is illustrated. The motor includes a stator 1, a rotor 3 (see FIG. 2) disposed in the stator, a coil 2 wound around an iron core of the stator 1, and an insulating apparatus.

The stator 1 and the rotor 3 of the motor have been described above with respect to the description of the related art, and thus, their description here will be omitted.

The coil 2 includes a main-resistance coil 2a and a sub-resistance coil 2b. The main-resistance coil 2a is wound around an outer portion of an iron core of the stator, while the sub-resistance coil 2b is wound around an inner portion of the iron core of the stator.

The insulating apparatus includes an insulator 10 that is disposed between the sub-resistance coil 2b and the rotor 3. The insulator 10 is ring-shaped and has a predetermined thickness as shown in FIG. 4. The insulator 10 is preferably refrigerant-proof and oil-proof in order to efficiently insulating the rotor 3 from the sub-resistance coil 2b.

The insulating apparatus further includes a yarn 20 for securing the insulator 10 to the main-resistance and sub-resistance coils 2a and 2b, respectively. The yarn 20 is preferably made of a polyester material. As constructed above, the insulator 10 and coil 2 are held in place by the yarn 20.

In the motor of the present invention, the insulator 10 and yarn 20 of the insulating apparatus prevent withstand voltage of the stator by insulating the rotor 3 from the sub-resistance coil 2b. Accordingly, although the sub-resistance coil 2b may expand and become loose due to an increase in temperature during operation of the motor, the sub-resistance coil 2b will not contact the rotor 3. Consequently, the withstand voltage caused by the contact between the sub-resistance coil 2b and the rotor 3 can be prevented.

As described above, a failure rate of a device, such as a compressor, that employs the motor of the present invention is decreased by insulating the rotor from the sub-resistance coil, to thereby prevent withstand voltage. Accordingly, one advantage of the present invention is that the quality of a product and productivity can be increased.

While the invention has been described with respect to a specific embodiment, those skilled in the art will appreciate that changes can be made in form and detail without departing from the spirit and scope of the invention, as defined by the following claims.

What is claimed is:

1. A motor comprising:
a stator having an iron core;
a rotor disposed in the stator;
a coil having a main-resistance coil and a sub-resistance coil, the main-resistance coil being wound around an outer portion of the iron core, the sub-resistance coil being wound around an inner portion of the iron core; and
insulating means for preventing withstand voltage which is caused by contact between the sub-resistance coil and the rotor when the sub-resistance coil expands due to an increase in temperature of the coil.

2. The motor as claimed in claim 1, wherein the insulating means comprises an insulator which is refrigerant-proof and oil-proof, the insulator being disposed between the sub-resistance coil and the rotor.

3. The motor as claimed in claim 2, wherein the insulating means further comprises a yarn for securing the insulator to the coil.

4. The motor as claimed in claim 3, wherein the yarn is made of a polyester material.

5. A motor comprising:
a stator having an iron core;
a rotor disposed in the stator;
a coil would around t he iron core of the stator; and
an insulating apparatus separating the rotor from the coil, the insulating apparatus preventing contact between the coil and the rotor when the coil expands during operation of the motor.

6. The motor as claimed in claim 5, wherein insulating apparatus comprises:
an insulator having a cylindrical shape; and
a yam securing the insulator to the coil.

7. The motor as claimed in claim 6, wherein the coil includes a main-resistance coil and a sub-resistance coil, the sub-resistance coil being wound around an inner portion of the iron core of the stator, and wherein the insulator is disposed between the sub-resistance coil and the rotor.

8. The motor as claimed in claim 6, wherein the insulator comprises a refrigerant-proof and oil-proof material.

9. The motor as claimed in claim 5, wherein the yarn is made of a polyester material.
